(19) United States
(12) Patent Application Publication
(10) Pub. No.: US 2003/0128384 A1
(43) Pub. Date: Jul. 10, 2003

(54) Dynamic load-balancing print server systems and methods

(76) Inventors: Dean S. Nelson, Meridian, ID (US); Janine L. Helms, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/039,198

(22) Filed: Jan. 4, 2002

(51) Int. Cl. B41J 1/00; G06F 15/00

(52) U.S. Cl. 358/1.15

(57) ABSTRACT

Systems and methods of a load-balancing print server system are disclosed. A representative load-balancing print server system of the present invention includes a primary print server. The primary print server is configured receive printing request data corresponding to a printing request and determine if the primary print server is able to process the printing request data. The primary print server also is configured to communicatively couple with another print server and transmit print queue data to another print server. Additionally, the primary print server is configured to transmit secondary destination print data to the source of the primary request data indicating that the source is to transmit the information corresponding to the print task to another print server.

### FIELD OF THE INVENTION

The present invention is generally related to print servers and, more particularly, is related to systems and methods for load-balancing printing requests received by print servers.

### DESCRIPTION OF THE RELATED ART

Generally, distributed printing systems use first-in-first-out (FIFO) queuing, where print operations (“print jobs”) from multiple users typically are sent to one of a number of printers. Such a system does not optimally utilize its resources, as certain printers inevitably handle more job requests than do other available printers. In such a scenario, one printer may have a print job queue containing many jobs, resulting in long delay times in printing, while other printers are in an idle state (i.e., not in current use).

Another related problem arises when a print server receives many print requests from multiple users. A print server is a computer that is dedicated to managing printers on a network. The print server includes a print spooler, which accepts and stores in memory information corresponding to a print task. In this regard, the print server is capable of receiving, processing, scheduling, and distributing information corresponding to documents for printing. When the print server reaches maximum or near maximum processing and/or storage capacity, the printing process slows down and operates in an inefficient manner. However, this problem is distinct from the situation discussed above because, here, the print server is causing the delay rather than the printer.

Reference is now made to FIG. 1A to further illustrate the aforementioned print server scenario. FIG. 1A is a schematic that illustrates a print server system 10. The print server system 10 includes a plurality of users (e.g., computers, workstations, or servers) 11, 12, and 13, a print server 14, and a plurality of printers 16, 17, and 18. Typically, a user 11, 12, or 13, can select a printer 16, 17, or 18, to print a print task. FIG. 1B is a flow diagram that illustrates how a printing request may be processed using a print server system 10, as shown in FIG. 1A. For example, user 13 sends a print request to print server 14 indicating that printer 18 is to print the printing task corresponding to the printing request. Generally, the information corresponding to the printing request is processed by print server 14, which then routes the information corresponding to the print task to printer 18. The print server problem discussed above arises because the print server 14 receives multiple print requests from users 11, 12, and/or 13, resulting in the print server 14 reaching maximum or near maximum processing capacity. Thus, the print server 14 may not be optimally utilized. In other words, the print server 14 is not able to efficiently process any more printing requests. Inefficient use of the print server 14 may cause printing delays and reduce employee productivity.

Thus, a heretofore unaddressed need exists in the industry to address the aforementioned and/or other deficiencies and/or inadequacies.

### SUMMARY OF THE INVENTION

A representative load-balancing print server system of the present invention includes a primary print server. The primary print server is configured receive printing request data corresponding to a printing request and determine if the primary print server is able to process the printing request data. The primary print server also is configured to communicatively couple with another print server and transmit print queue data to another print server. Additionally, the primary print server is configured to transmit secondary destination print data to the source of the primary request data indicating that the source is to transmit the information corresponding to the print task to another print server.

The present invention also involves methods for load-balancing a print server system. A representative method includes: receiving printing request data that corresponds to a printing request at a primary destination; selecting a secondary destination to process the printing request; and transmitting print queue data to the secondary destination, the print queue data including information corresponding to the printing request.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1A is a schematic diagram of a print server system of the prior art.

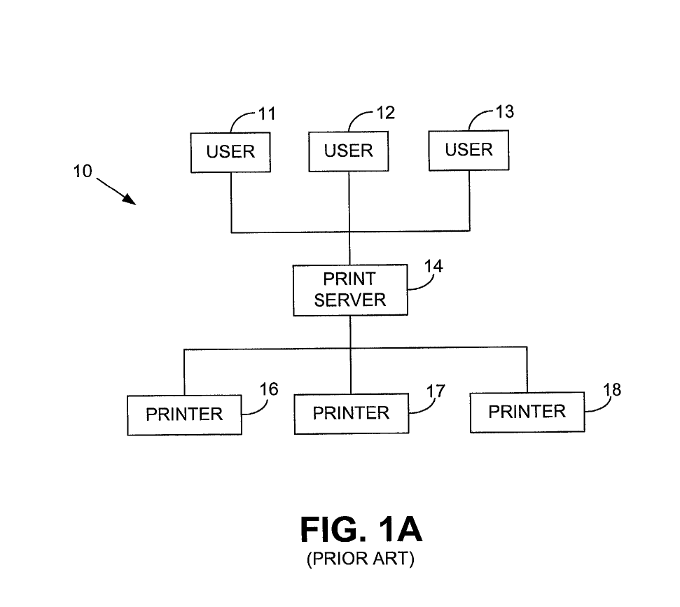

FIG. 1B is a block diagram illustrating how a printing request and a print task flows from the user to the printer in the prior art print server system of FIG. 1A.

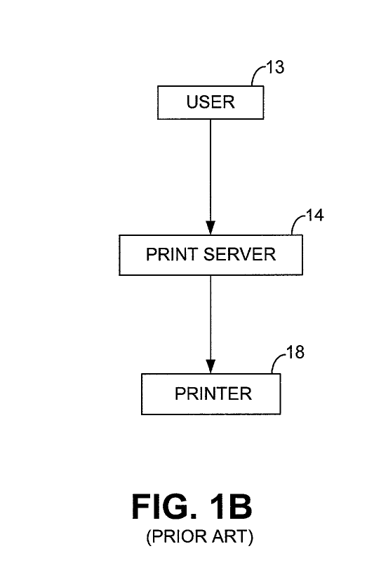

FIG. 2A is a schematic diagram of one embodiment representative of a load-balancing print server system of the present invention.

FIG. 2B is a block diagram illustrating a representative flow of a printing request and a print task through the load-balancing print server system illustrated in FIG. 2A.

FIG. 3 is a schematic diagram of one embodiment representative of the primary print server system illustrated in FIG. 2A.

FIG. 4 is a flow diagram illustrating representative functionality of an embodiment of the primary print server system illustrated in FIG. 3.

FIG. 5 is a flow diagram illustrating representative functionality of an aspect of the embodiment of the primary print server system illustrated in FIG. 4.

FIG. 6 is a schematic diagram of one embodiment representative of the secondary print server system illustrated in FIG. 2A.

FIG. 7 is a flow diagram illustrating representative functionality of an embodiment of the secondary print server system illustrated in FIG. 6.

FIG. 8 is a flow diagram illustrating representative functionality of the load-balancing print server system illustrated in FIG. 2A.

### DETAILED DESCRIPTION

Dynamic load-balancing print server systems and methods of the present invention (hereinafter “load-balancing print server system”) potentially exhibit increased efficiency of print operations compared to print server systems of the prior art. In particular, the load-balancing print server system is configured to transfer printing requests from a primary print server to an secondary print server to increase the efficiency of the load-balancing print server system. In other words, when the primary print server reaches a threshold level of processing capacity, the primary print server can transfer one or more printing requests to a secondary print server. Thus, load-balancing print server systems can enhance printing efficiency by reducing the load of printing request imbalance between two or more print servers.

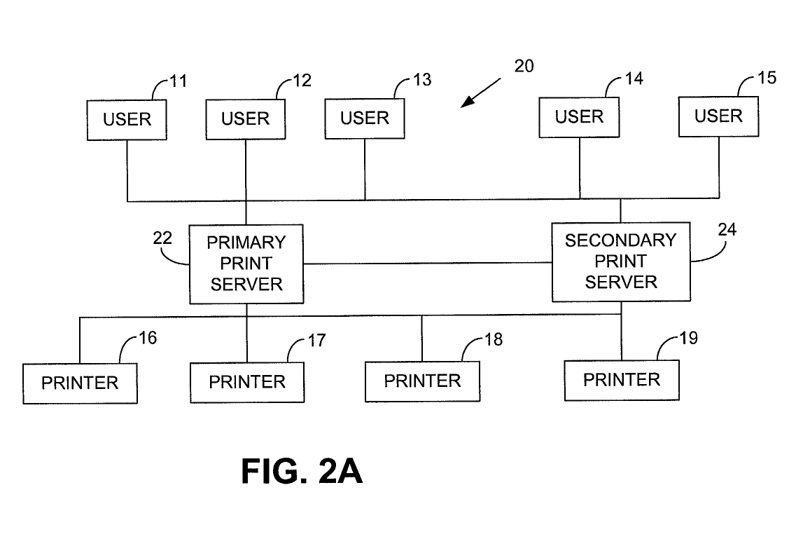

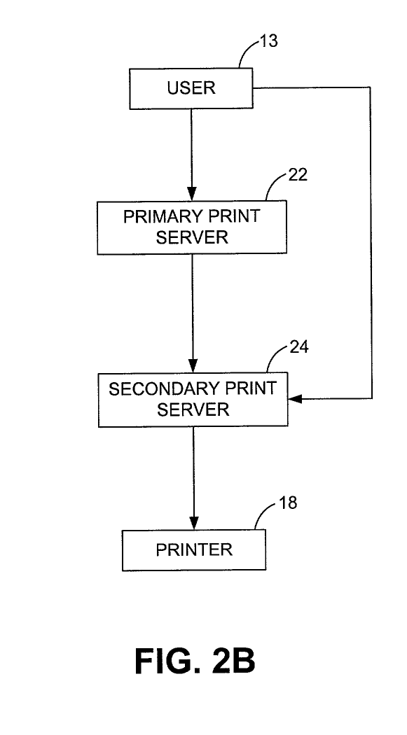

Referring again to the drawings, FIG. 2A is a schematic that illustrates a representative load-balancing print server system 20. Load-balancing print server 20 system includes a plurality of users 11, 12, 13, 14, and 15, two or more print servers 22 and 24, and a plurality of printers 16, 17, 18, and 19. Generally, users 11-13 send print tasks to print server 22, while users 14-15 send print tasks to print server 24. Load-balancing print server system 20 is configured to enable primary print server 22 to allocate (e.g., transfer) one or more printing queues and any additional incoming print tasks to secondary print server 24. In this regard, primary print server 22 is configured to send information to the user 11, 12, or 13, indicating that the user 11, 12, or 13, send information corresponding to the print task to the secondary print queue on secondary print server 24. Secondary print server 24 is configured to receive print queue task data from primary print server 22. In addition, secondary print server 24 is configured to receive information corresponding to the print task from the user 11, 12, or 13. Thereafter, secondary print server 24 is configured to transfer the information corresponding to the print task to the printer 16, 17, or 18.

FIG. 2B is a block diagram that illustrates the functionality of the representative load-balancing print server system 20 illustrated in FIG. 2A. Initially, user 13 sends printing request data that corresponds to a printing request to primary print server 22. Primary print server 22 is configured to determine if it is operating at a pre-determined threshold (e.g., near maximum utilization of the processing and/or storage of the print server). If print server 22 is operating at the pre-determined threshold, then primary print server 22 is configured to communicate with secondary print server 25. Primary print server 22 and secondary print server 24 are configured to determine if secondary print server 24 can process the printing request data that primary print server 22 is currently unable to efficiently process. If secondary print server 24 can process the printing request, primary print server 22 sends print queue data to secondary print server 24. In addition, primary print server 22 sends secondary print destination data to the appropriate user 11, 12, or 13, indicating the that user 11, 12, or 13, send the information corresponding to the print task to secondary print server 24. Thereafter, the user 11, 12, or 13, sends information corresponding to the print task to the secondary print queue on secondary print server 24. Secondary print server 24 is configured to receive print queue data and information corresponding to the print task. Subsequently, secondary print server 24 is configured to process the information corresponding to the print task and transmit the information corresponding to the print task to the printer 16, 17, or 18.

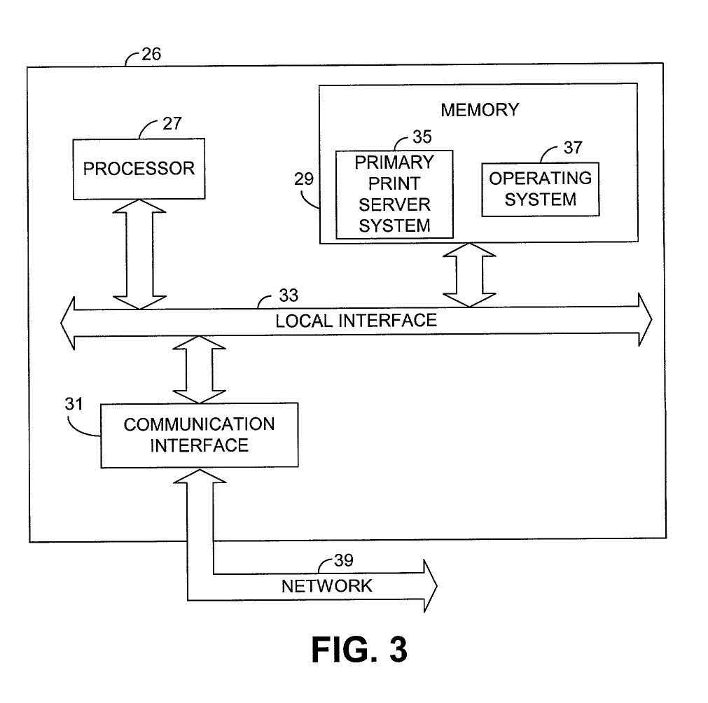

Primary print server 22 includes primary print server system 35 as shown in FIG. 3. Primary print server system 35 can be implemented in software (e.g., firmware), hardware, or a combination thereof. Primary print server 22 can include a special or general purpose digital computer or a processor-based system (hereinafter computer 26) that can implement primary print server system 35.

Generally, in terms of hardware architecture, as shown in FIG. 3, the computer 26 includes a processor 27, memory 29, and communication interface 31, that are communicatively coupled via a local interface 33. The local interface 33 can be, for example, one or more buses or other wired or wireless connections, as is known in the art. The local interface 33 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The computer 26 may be interfaced to one or more devices, such as a computer, printer, or server, through the communication interface 31 via a network 39. The network 39 can be one or more networks capable of enabling the above components to communicate and may include, for example, local area network (LAN), wireless local area network (WLAN), a metropolitan area network (MAN), a wide area network (WAN), any public or private packet-switched or other data network, including the Internet, circuit-switched networks, such as the public switched telephone network (PSTN), wireless networks, or any other desired communications infrastructure.

The processor 27 is a hardware device for executing software, particularly that stored in memory 29. The processor 27 can be any custom made or commercially available processor, a central processing unit (CPU), an auxiliary processor among several processors associated with the computer 26, a semiconductor based microprocessor (in the form of a microchip or chip set), a macroprocessor, or generally any device for executing software instructions.

The memory 29 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 29 may incorporate electronic, magnetic, optical, and/or other types of storage media. Note that the memory 29 can have a distributed architecture, where various components are situated remote from one another, but can be accessed by the processor 27.

The software in memory 29 may include one or more separate programs, each of which comprises an ordered listing of executable instructions for implementing logical functions. In the example of FIG. 3, the software in the memory 29 includes primary print server system 35 and a suitable operating system 37 (O/S). The operating system 37 essentially controls the execution of other computer programs, such as primary print server system 35, and provides scheduling, input-output control, file and data management, memory management, and communication control and related services.

Primary print server system 35 can be a source program, executable program (object code), script, or any other entity comprising a set of instructions to be performed. When a source program, then the program may need to be translated via a compiler, assembler, interpreter, or the like, which may or may not be included within the memory 29, so as to operate properly in connection with the O/S 37. Furthermore, primary print server system 35 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The computer 26 may further include a basic input output system (BIOS) (omitted for simplicity). The BIOS is a set of essential software routines that initialize and test hardware at startup, start the O/S 37, and support the transfer of data among the hardware devices. The BIOS is stored in ROM so that the BIOS can be executed when the computer 26 is activated.

When the computer 26 is in operation, the processor 27 is configured to execute software stored within the memory 29, to communicate data to and from the memory 29, and to generally control operations of the computer 26 pursuant to the software. Primary print server system 35 and the O/S 37, in whole or in part, but typically the latter, are read by the processor 27, perhaps buffered within the processor 27, and then executed.

When primary print server system 35 is implemented in software, as is shown in FIG. 3, it should be noted that primary print server system 35 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The primary print server system 35 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, by way of optical scanning of the paper or other medium, then compiled, interpreted or otherwise processed in a suitable manner if necessary, and then stored in a computer memory.

In an alternative embodiment, where primary print server system 35 is implemented in hardware, primary print server system 35 can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

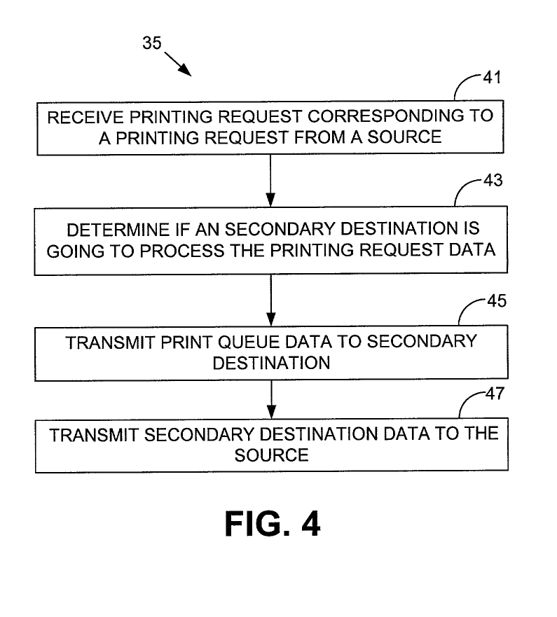

Reference will now be made to the flow diagram of FIG. 4, which illustrates a representative embodiment of primary print server system 35. In this regard, each block of the flowchart represents a module segment, portion of code, or logic circuit(s) for implementing the specified logical function(s). It should also be noted that in some alternative implementations the functions noted in various blocks of FIG. 4, or any other of the accompanying flowcharts, may occur out of the order in which they are depicted. For example, two blocks shown in succession in FIG. 4 may, in fact, be executed substantially concurrently. In other embodiments, the blocks may sometimes be executed in the reverse order depending upon the functionality involved.

FIG. 4 illustrates the functionality of a representative embodiment of primary print server system 35. Primary print server system 35 receives printing request data corresponding to a print request from a source (e.g., computer, workstation, or server) as shown in block 41. After receiving the printing request data, primary print server system 35 determines if a secondary destination (e.g., secondary print server) is able to process the printing request, as shown in block 43. Thereafter, the primary print server system 35 transmits print queue data to the secondary print server, as shown in block 45. In addition, primary print server system 35 transmits secondary print destination data to the source of the printing request, as shown in block 47.

The printing queue data includes information such as, for example, information included in the printing request destination, device information, and communication information. The device information may include for example device name, device type, device driver, installed add-on information, additional driver information for add-ons, media information, (e.g., paper, toner, etc.). The communication information may include, for example, communication information, destination device address, host name, destination device communication port, or communication protocol.

The secondary print destination data includes information such as, for example, information indicating the address of the secondary print server 37 and any other information that may be needed by the source to transmit the information corresponding to the print task to the secondary print server 37. In another embodiment the secondary print destination data can include the printing queue data. In that embodiment, primary print server system 35 may not have to be configured to transmit the printing request data to the secondary print server 37.

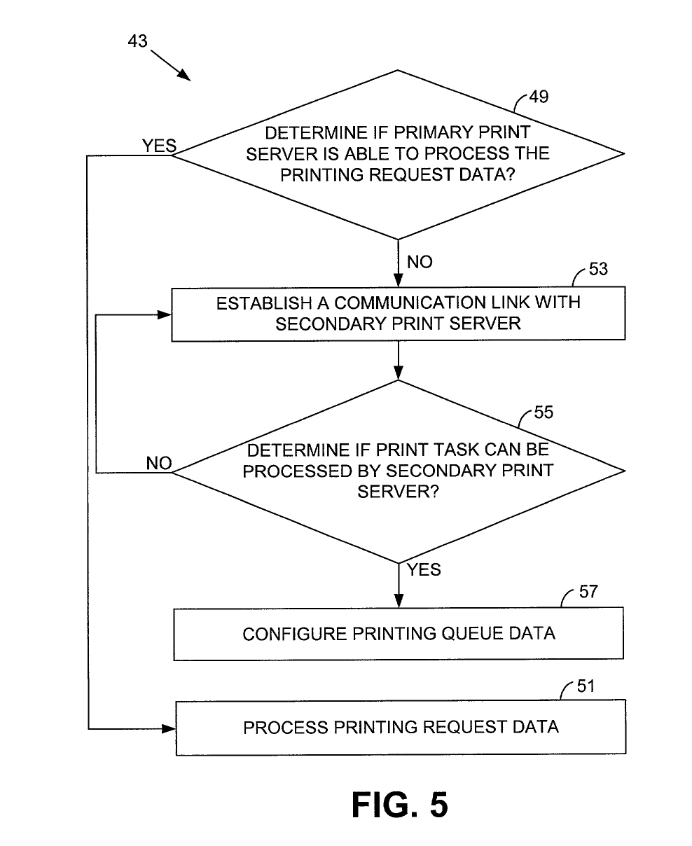

FIG. 5 illustrates the functionality of a representative embodiment of the process to determine the secondary print server 37 as shown in block 43, FIG. 4. Initially, a determination is made to determine if primary print server 22 is going to process the printing request, as shown in block 49. If the determination is “yes,” then the printing request is processed, as shown in block 51. If the determination is “no,” then a communication link is established with a secondary print server 37, as shown in block 53. After establishing communication with the secondary print server 37, a determination is made to determine if the printing request is to be processed by the secondary print server 37, as shown in decisional block 55. If the determination is “no,” then communication is established with another secondary print server, as indicated by the loop from block 55 back to block 53. If the determination is “yes,” then printing queue data is created, as shown in block 57.

The determination step discussed in reference to block 43 of FIG. 4 can include determining if secondary print server 24 is going to process one or more printing requests for primary print server 22. For example, the determination may indicate that secondary print server 24 is going to process a certain number of printing requests. In addition, the determination may indicate that secondary print server 24 is going to process print requests for a specific period of time. Further, the determination may include that secondary print server 24 process printing requests until indicated by primary print server 22 to not process any more printing requests. In all of these cases, primary print server 22 and secondary print server 24 communicate (e.g., handshake) to ensure that the print task is processed by the secondary print server 24. In addition, primary print server 22 and secondary print server 24 can communicate to indicate that primary print server 22 is no longer allocating print tasks to secondary print server 24.

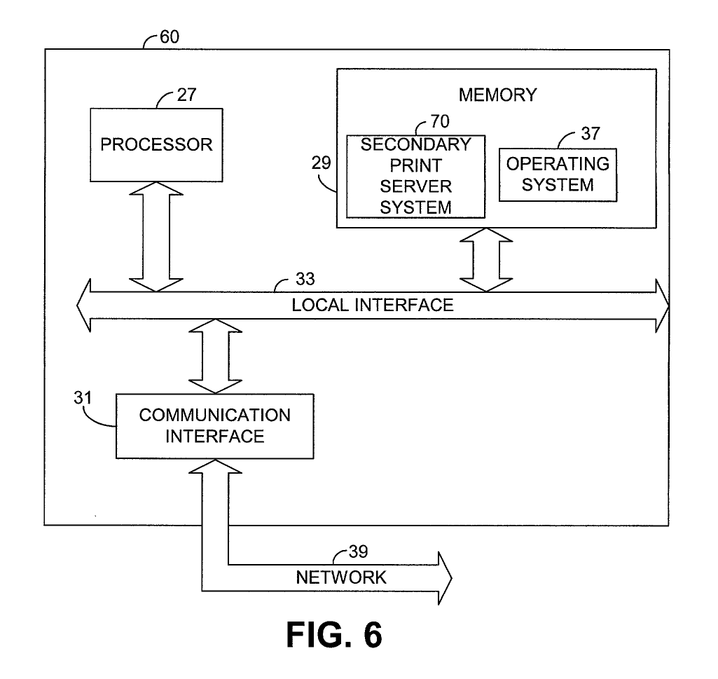

FIG. 6 is a schematic that illustrates alternative print server 24, which includes a secondary print server system 70. Secondary print server system 70 can be implemented in hardware, software, firmware, or a combination thereof Secondary print server 70 includes a special or general purpose digital computer or a processor-based system (hereinafter computer 60) that can implement secondary print server system 70.

Computer 60 is similar to the computer 26 illustrated in FIG. 3 and therefore, will only be described briefly. Computer 60 includes a processor 27, a memory 29, a communications interface 31, a network 39, and/or a local interface 33. Functionality of these components are the same or similar to the corresponding components discussed in reference to the computer 26 of FIG. 3.

When secondary print server system 70 is implemented in software, as is shown in FIG. 6, it should be noted that secondary print server system 70 can be stored on any computer readable medium for use by or in connection with any computer related system or method.

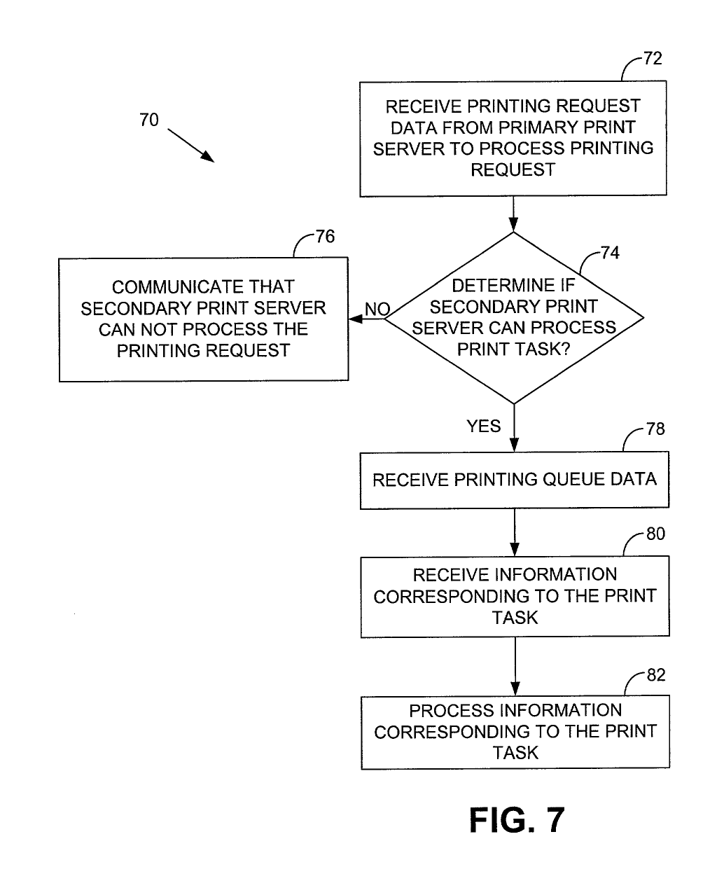

Reference will now be made to the flow diagram of FIG. 7, FIG. 7 illustrates a functionality of a representative embodiment of secondary print server system 70. Print queue data is received indicating a request to process a printing request, as shown in block 72. In decisional block 74, a determination is made to determine if secondary print server 37 is able to process the printing request. If the determination is “no,” a communication is sent to the secondary print server 24 indicating that it can not process the printing request, as shown in block 76. If the determination is “yes,” print queue data is received, as shown in block 78. In addition, information corresponding to the print task is received, as shown in block 80. Thereafter, the information corresponding to the print task is processed and can be transmitted to a selected printer, as shown in block 82.

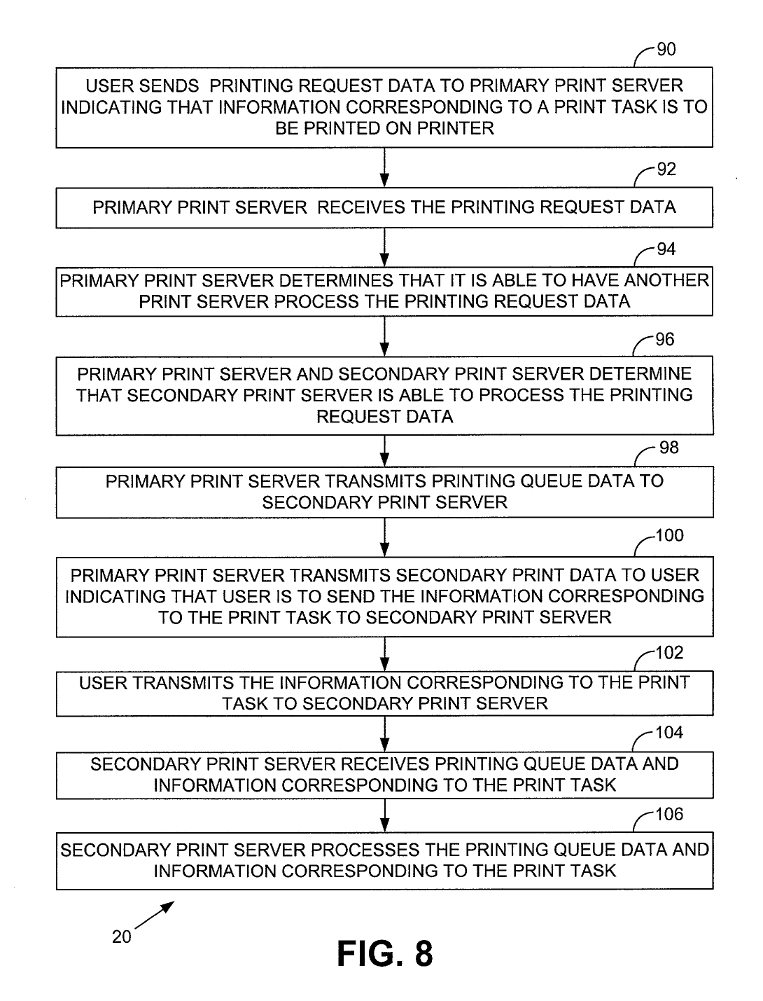

Reference will now be made to an exemplary representation of the load-balancing print server system 20. The load-balancing print server system 20, as shown in FIG. 2 is an exemplary system for performing the functions described in FIG. 8. In block 90, a user 11, 12, or 13, can send printing request data to primary print server 22 indicating that information corresponding to a print task that is associated with the printing request is to be printed on a printer 16, 17, or 18. Primary print server 22 is configured to receive the print request data, as shown in block 92. In addition, primary print server 22 is configured to determine that it is going to have secondary print server 24 process the printing request, as shown in block 94. Primary print server 22 and secondary print server 24 are configured to determine that secondary print server 24 is going to process the printing request, as shown in block 96. Then, primary print server 22 is configured to transmit print queue data to the secondary print queue on secondary print server 24, as shown in block 98. In addition, primary print server 22 is configured to transmit secondary print destination data to the user indicating that the user is to transmit the information corresponding to the print task to secondary print server 24, as shown in block 100. Thereafter, the user transmits the information corresponding to the print task to the secondary print queue on secondary print server 24, as shown in block 102. Secondary print server 24 is configured to receive and process the print queue data and the information corresponding to the printing request, as shown in blocks 104 and 106.

Therefore, the embodiments of the load-balancing print server system 20 of the present invention may overcome the deficiencies discussed above by enabling primary print server 22 to allocate printing requests to secondary print server 24.

Many variations and modifications may be made to the above-described embodiment(s) of the load-balancing print server system 20 without departing substantially from the spirit and principles of the invention. For example, secondary print server 24 can be configured to transmit the information corresponding to the print task to an secondary printer 19 if the designated printer is near full capacity out of print media, or otherwise unable to process the print task. All such modifications and variations are intended to be included herein within the scope of this disclosure and the present invention and protected by the following claims.

1. A method for balancing printing request loads, comprising:
receiving printing request data that corresponds to a printing request at a primary destination;
selecting a secondary destination to process the printing request; and
transmitting print queue data to the secondary destination, the print queue data including information corresponding to the printing request.

2. The method of claim 1, wherein:
receiving comprises receiving multiple print request data that corresponds to multiple print requests at the primary destination; and
transmitting comprises transmitting print request data that corresponds to at least one of the print requests to the secondary destination.

3. The method of claim 1, wherein the printing request data is received from a source; and further comprising:
transmitting secondary print destination data to the source, the secondary print destination data including information corresponding to the secondary destination.

4. The method of claim 1, wherein selecting further includes:
communicating with the secondary destination; and
determining if the secondary destination is able to process the printing request.

5. The method of claim 3, further comprising:
creating the print queue data; and
creating the secondary print destination data.

6. The method of claim 1, further comprising:
receiving the printing request from a source; and
transmitting secondary print destination data indicating that the source is to transmit information corresponding to a print task to the secondary destination.

7. The method of claim 4, further comprising:
determining if the secondary destination is able to continue processing additional printing requests.

8. The method of claim 1, further comprising:
sending the information corresponding to the print task to the secondary destination.

9. The method of claim 1, further comprising:
receiving the print queue data; and
receiving information corresponding to a print task.

10. A system for load-balancing comprising:
a primary print server configured to:
receive printing request data corresponding to a printing request;
determine if the primary print server is able to process the printing request data;
communicatively couple with another print server;
transmit print queue data to another print server; and
transmit secondary print destination data to the source of the primary request data indicating that the source is to transmit the information corresponding to the print task to another print server.

11. The system of claim 10, further comprising:
a source of a printing request for a printing task.

12. The system of claim 10, further comprising:
a secondary print server communicatively coupled to the primary print server, a secondary print server system configured to receive the print queue data, and wherein the secondary print server is configured to receive information corresponding to the print task.

13. The system of claim 12, wherein the primary print server is configured to determine if the secondary print server is able to process the printing request data.

14. The system of claim 10, wherein the primary print server is configured to produce the print queue data and the secondary print destination data.

15. The system of claim 12, wherein the secondary print destination data indicates that the source is to transmit information corresponding to the print task to the secondary print server.

16. The system of claim 10, wherein the primary print server includes:
means for receiving printing request data that corresponds to the printing request from a source;
means for selecting a secondary print server to process the printing request;
means for transmitting the print queue data to the secondary print server, the print queue data including information corresponding to the printing request; and
means for transmitting the secondary print destination data to the source, the secondary print destination data including information corresponding to the secondary destination print server.

17. The system of claim 12, wherein the secondary print server includes:
means for receiving print queue data; and
means for receiving secondary print destination data.

18. A computer readable medium for use in a computer system for balancing printing request loads, said computer readable medium comprising:
logic configured to enable printing request data that corresponds to a printing request from a source to be received by a first destination;
logic configured to enable a secondary destination to be selected, wherein the secondary destination processes the printing request; and
logic configured to enable print queue data to be transmitted to the secondary destination, wherein the print queue data includes information corresponding to the printing request.

19. The computer readable medium of claim 18, further comprising:
logic configured to enable secondary print destination data to be transmitted to the source, the secondary print destination data including information corresponding to the secondary destination.

20. The computer readable medium of claim 19, further comprising:
logic configured to enable the print queue data to be created; and
logic configured to enable the secondary print destination data to be created.

21. The computer readable medium of claim 18, further comprising:
logic configured to enable the print queue data to be received; and
logic configured to enable information corresponding to a print task to be received.

22. The computer readable medium of claim 18, wherein:
logic configured to enable printing request data that corresponds to a printing request from a source to be received by a first destination further comprising logic configured to enable multiple print request data that corresponds to multiple print requests to be received at the primary destination; and
logic configured to enable print queue data to be transmitted to the secondary destination further comprising logic configured to enable print request data that corresponds to at least one of the print requests to be transmitted to the secondary destination.

23. The computer readable medium of claim 18, wherein logic configured to enable a secondary destination to be selected further comprising:
logic configured to enable communication with the secondary destination; and
logic configured to enable the secondary destination to determine if it is able to process the printing request.

24. The computer readable medium of claim 23, further comprising:
logic configured to enable the secondary destination to determine if it is able to continue processing additional printing requests.

25. The computer readable medium of claim 18, further comprising:
logic configured to enable the printing request from a source to be received; and
logic configured to enable the secondary print destination data indicating that the source is to transmit information corresponding to a print task to the secondary destination to be transmitted.

26. The computer readable medium of claim 18, further comprising:
logic configured to enable the information corresponding to the print task to be sent to the secondary destination.
